(19) United States
(12) Patent Application Publication
(10) Pub. No.: US 2025/0015957 A1
(43) Pub. Date: Jan. 9, 2025

(54) METHOD FOR INDICATING TIMING ADVANCE, TERMINAL DEVICE AND NETWORK DEVICE

(71) Applicant: GUANGDONG OPPO MOBILE TELECOMMUNICATIONS CORP., LTD., Dongguan (CN)

(72) Inventors: Jianfei CAO, Dongguan (CN); Wenhong CHEN, Dongguan (CN); Zhihua SHI, Dongguan (CN)

(21) Appl. No.: 18/897,402

(22) Filed: Sep. 26, 2024

Related U.S. Application Data
(63) Continuation of application No. PCT/CN2022/089906, filed on Apr. 28, 2022.

(51) Int. Cl. H04L 5/00; H04W 72/231

(52) U.S. Cl. CPC H04L 5/0053; H04L 5/0005; H04W 72/231

(57) ABSTRACT

Provided is a method for indicating TAs. The method is applicable to a terminal device and the method includes: receiving downlink signaling, wherein the downlink signaling at least carries a first association parameter, the first association parameter having an association relationship with a first TA, and the first association parameter corresponding to a first spatial filter; and updating a TA of the first spatial filter based on the downlink signaling.

### CROSS-REFERENCE TO RELATED APPLICATION

This application is a continuation application of international application No. PCT/CN2022/089906, filed on Apr. 28, 2022, the disclosure of which is incorporated herein by reference in its entirety.

### TECHNICAL FIELD

The present disclosure relates to the field of communications, and in particular, relates to a method for indicating a timing advance, and a terminal device and a network device thereof.

### BACKGROUND

A timing advance (TA) is configured for uplink transmission of a terminal device. The TA indicates that the terminal device transmits a system frame of uplink data in a specific amount of timing advance compared to a corresponding downlink frame, such that signals from different terminal devices in the same subframe with different frequency domain resources arrive at a network device essentially at the same time.

### SUMMARY

Embodiments of the present disclosure provide a method for indicating TAs, and a terminal and a network device thereof. The technical solutions are as follows.

According to some embodiments of the present disclosure, a method for indicating TAs is provided. The method is applicable to a terminal device. The method includes: receiving downlink signaling, wherein the downlink signaling at least carries a first association parameter, the first association parameter having an association relationship with a first TA, and the first association parameter corresponding to a first spatial filter; and updating a TA of the first spatial filter based on the downlink signaling.

According to some embodiments of the present disclosure, a method for indicating TAs is provided. The method is applicable to a network device. The method includes: transmitting downlink signaling, wherein the downlink signaling at least carries a first association parameter, the first association parameter having an association relationship with a first TA, and the first association parameter corresponding to a first spatial filter; wherein the downlink signaling is configured for the terminal device to update a TA of the first spatial filter.

According to some embodiments of the present disclosure, a terminal device is provided. The terminal device includes:
a processor;
a transceiver coupled to the processor; and
a memory, configured to store one or more executable instructions of the processor;
wherein the processor, when loading and executing the one or more executable instructions, is caused to perform the method as described above.

According to some embodiments of the present disclosure, a network device is provided. The network device includes:
a processor;
a transceiver coupled to the processor; and
a memory, configured to store one or more executable instructions of the processor;
wherein the processor, when loading and executing the one or more executable instructions, is caused to perform the method as described above.

### BRIEF DESCRIPTION OF DRAWINGS

For clearer descriptions of the technical solutions according to the embodiments of the present disclosure, the following briefly describes accompanying drawings required for describing the embodiments. Apparently, the accompanying drawings in the following description illustrate merely some embodiments of the present disclosure, and those of ordinary skill in the art can still derive other accompanying drawings from these accompanying drawings without creative efforts.

FIG. 1 is a schematic diagram of a medium access control (MAC) control element (CE) according to some embodiments of the present disclosure;

FIG. 2 is a schematic diagram of a MAC CE according to some embodiments of the present disclosure;

FIG. 3 is a schematic diagram of a communication system according to some embodiments of the present disclosure;

FIG. 4 is a flowchart of a method for indicating TAs according to some embodiments of the present disclosure;

FIG. 5 is a schematic diagram of acquiring a TA value by measuring different synchronization signal blocks (SSBs) according to some embodiments of the present disclosure;

FIG. 6 is a schematic diagram of acquiring a TA value over a physical random access channel (PRACH) according to some embodiments of the present disclosure;

FIG. 7 is a schematic diagram of a unified transmission configuration indication (TCI) state associated with a TA in a single-transmission and reception point (single-TRP) scenario according to some embodiments of the present disclosure;

FIG. 8 is a schematic diagram of a unified TCI state associated with the TA in an inter-cell mobility management scenario according to some embodiments of the present disclosure;

FIG. 9 is a schematic diagram of a MAC CE according to some embodiments of the present disclosure;

FIG. 10 is a schematic diagram of a MAC CE according to some embodiments of the present disclosure;

FIG. 11 is a schematic diagram of a MAC CE according to some embodiments of the present disclosure;

FIG. 12 is a schematic diagram of a MAC CE according to some embodiments of the present disclosure;

FIG. 13 is a flowchart of a method for indicating TAs according to some embodiments of the present disclosure;

FIG. 14 is a flowchart of a method for indicating TAs according to some embodiments of the present disclosure;

FIG. 15 is a schematic diagram of a MAC CE according to some embodiments of the present disclosure;

FIG. 16 is a schematic diagram of a MAC CE according to some embodiments of the present disclosure;

FIG. 17 is a schematic diagram of a MAC CE according to some embodiments of the present disclosure;

FIG. 18 is a schematic diagram of a MAC CE according to some embodiments of the present disclosure;

FIG. 19 is a schematic diagram of a MAC CE according to some embodiments of the present disclosure;

FIG. 20 is a schematic diagram of a MAC CE according to some embodiments of the present disclosure;

FIG. 21 is a schematic diagram of a MAC CE according to some embodiments of the present disclosure;

FIG. 22 is a flowchart of a method for indicating TAs according to some embodiments of the present disclosure;

FIG. 23 is a flowchart of a method for indicating TAs according to some embodiments of the present disclosure;

FIG. 24 is a structural block diagram of an apparatus for indicating TAs according to some embodiments of the present disclosure;

FIG. 25 is a structural block diagram of an apparatus for indicating TAs according to some embodiments of the present disclosure; and

FIG. 26 is a schematic structural diagram of a communication device according to some embodiments of the present disclosure.

### DEILED DESCRIPTION

For clearer descriptions of the objectives, technical solutions, and advantages of the present disclosure, embodiments of the present disclosure are further described in detail hereinafter with reference to the accompanying drawings.

First, technical knowledge involved in the embodiments of the present disclosure is briefly described hereinafter.

### TA

In an existing new radio (NR) standard (including 3GPP Rel.17), a terminal device may be configured with up to four TA groups (TAGs) in a cell group (CG). Generally, one CG may include a plurality of serving cells, wherein each of the plurality of serving cells is assigned a TAG-Id. A radio resource control (RRC) configuration of a TAG may be as follows.

-- ASN1START
-- TAG-TAG-CONFIG-START

| | |
|---|---|
| TAG-Config ::= | SEQUENCE { |

```
  tag-ToReleaseList SEQUENCE (SIZE (1..maxNrofTAGs)) OF TAG-Id OPTIONAL,
-- Need N
  tag-ToAddModList SEQUENCE (SIZE (1..maxNrofTAGs)) OF TAG OPTIONAL -
- Need N
  }
```

| | |
|---|---|
| TAG ::= | SEQUENCE { |
| tag-Id | TAG-Id, |

```
  timeAlignmentTimer TimeAlignmentTimer,
    ...
  }
```

| | |
|---|---|
| TAG-Id ::= | INTEGER (0..maxNrofTAGs−1) |

TimeAlignmentTimer ::= ENUMERATED {ms500, ms750, ms1280, ms1920, ms2560,
ms5120, ms10240, infinity}
-- TAG-TAG-CONFIG-STOP
-- ASN1STOP

A TA of the terminal device is calculated according to the formula: (N_{TA}+N_{TA,offset})*T_{C}. The TA of the terminal device means that transmission is performed in advance with a 1^{st} symbol of a downlink channel received by the terminal device or a slot of the channel as a downlink reference.

Parameters in the TA calculation formula are described hereinafter. In one CG, each serving cell may be preconfigured with a TA offset n-TimingAdvanceOffset, i.e., N_{TA,offset} in the formula. A TA adjustment amount N_{TA} is based on the preconfigured TA offset. T_{C} is a minimum time unit in an NR system. T_{C}=1/(4096*480 kHz).

Based on the above formula for calculating the TA, two TA update manners are available.

The first TA update manner is difference-based TA update. N_{TA} may be differentially updated based on a MAC CE from a network device. That is, a current TA is acquired by adjusting a previous TA forward or backward in time. A calculation formula is as follows:

$${N}_{( {TA}_{new} )} = {N}_{( {TA}_{old} )} + ( {T}_{A} - 31 ) * 16 * 64 * / {2}^{μ}$$

In the calculation formula, μ represents a value corresponding to a subcarrier spacing, N_{TA_old} represents an N_{TA} value before indication, N_{TA_new} represents a N_{TA} value after indication, and T_{A} represents a value indicated in the MAC CE. T_{A}=0, 1, 2, . . . , 63.

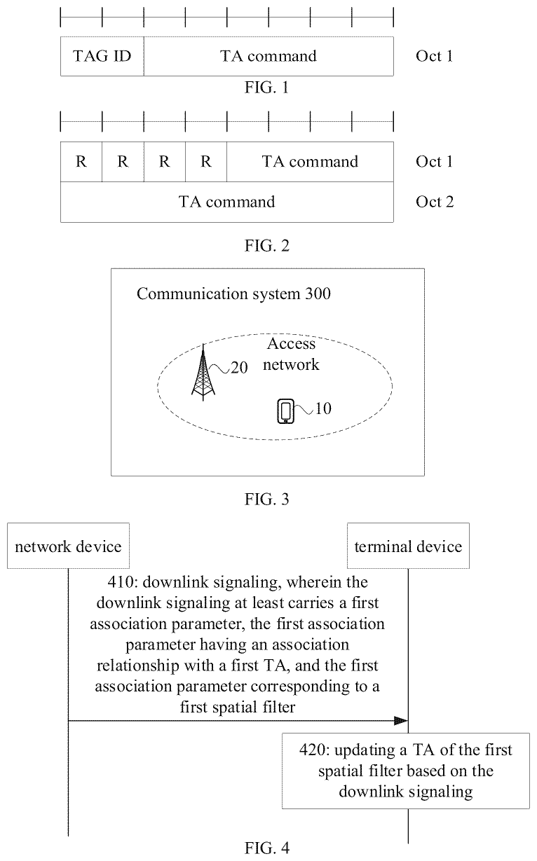

A differential adjustment format of a TA of a MAC CE is illustrated in FIG. 1. That is, the previous TA is adjusted by T_{A} minimum time units, wherein a granularity of the TA adjustment is TAG.

In FIG. 1, a Tag ID field is defined to identify a TAG. For example, a Tag ID of a TAG including a special cell (SpCell) is 0, wherein the Tag ID field is 2 bits in length. A TA command field indicates a TA index value (0, 1, 2, . . . , 63), wherein the TA index value is defined to control a timing adjustment amount that a MAC entity must apply (TS 38.213 [6]), and the TA command field is 6 bits in length.

The second TA update manner is absolute value-based TA update. An absolute value of a TA is adjusted. That is, a MAC CE from a network device directly provides an absolute value T_{A} without considering a previous TA value. T_{A}=0, 1, 2, . . . , 3846. A TA adjustment range is N_{TA}=T*16*64*2^{μ}. In addition, the TA command is applicable to a primary TAG (PTAG) corresponding to the MAC entity. The PTAG is defined as a TAG including a SpCell. Because the MAC CE is applicable only to the PTAG, the MAC CE does not need to include a TAG-Id.

An absolute value adjustment format of a TA of a MAC CE is illustrated in FIG. 2. In FIG. 2, a TA command field indicates a TA index value, wherein the TA index value is defined to control a timing adjustment amount that a MAC entity shall apply (TS 38.213 [6]), and the TA command field is 12 bits in length. An R field is a reserved bit and is set to 0.

### Uplink Beam Indication

The concept of unified TCI states is introduced in relevant standard protocols. For example, the downlink quasi-co-located (QCL) relationship is extended to the uplink. This QCL relationship may be simply described as a scenario where large-scale fading of a certain source reference signal and large-scale fading of a target reference signal are essentially identical, which may be considered as being transmitted from the same station address. Therefore, the source reference signal is capable of providing beam (large-scale fading) guidance for the target reference signal. With respect to the uplink, in the case that the terminal device transmits the target reference signal, the terminal device uses a transmit beam corresponding to a receive beam that is used to receive the source reference signal (channel-state information reference signal (CSI-RS) or SSB), or performs transmission over a beam of the transmitted source reference signal (sounding reference signal (SRS)).

The relevant standard protocols stipulate the unified TCI state, which add important new features. The examples are as follows.

Three modes of the unified TCI state are designed, that is, a joint TCI state, a downlink TCI (DL TCI) state, and an uplink TCI (UL TCI) state. The joint TCI state is applicable to uplink and downlink channels and signals, the DL TCI state is only applicable to downlink channels and signals, and the UL TCI state is only applicable to uplink channels and signals.

The downlink channels (partial physical downlink control channel (PDCCH), and physical downlink shared channel (PDSCH)) and signals (non-periodic CSI-RS), use the same downlink transmission indication beam, and use the downlink TCI state or the joint TCI state.

The uplink channel (physical uplink control channel (PUCCH), and physical uplink shared channel (PUSCH)) and the signal (SRS) use the same uplink transmission beam, and use the uplink TCI state or the joint TCI state.

The unified TCI state is dynamically updated and indicated by using a MAC CE and/or downlink control information (DCI).

In a carrier aggregation scenario, the beam indication of a single component carrier (CC) is applicable to a plurality of different CCs.

An uplink beam indication and an uplink power control parameter may be given simultaneously by the uplink TCI state or the joint TCI state (implemented by an association relationship).

An inter-cell beam management function is supported.

As described above, an existing TA indication technology can only adjust a TA with a granularity of TAG (including difference-based TA adjustment or absolute value-based TA adjustment). The minimum unit of the TAG is one serving cell.

That is, in the related art, the network device instructs, with a granularity being TA group (TAG), a terminal device to adjust a TA used by the terminal device. However, in some scenarios, for example, different uplink beams are used for uplink transmission, the TA used by the terminal device is not accurate.

For intra-cell single-TRP transmissions, a plurality of different uplink beams may correspond to different TAs. With respect to a plurality of uplink beams within one TRP, different uplink beams generally pass different uplink channels and propagation paths. Delay characteristics of the channels, such as delay extension and average delay, are significantly different. Therefore, a network device need to perform independent TA fine-adjustment for different uplink beams.

In the case of inter-cell mobility management, at most X (a classical value is X=7) cells have different physical cell identifiers (PCIs) for cell selection, and it is clear that different TA values are required for a terminal device to connect to different target cells.

Therefore, it is necessary to introduce a beam-specific TA update solution in the relevant standard protocols.

With respect to the above problem, in the embodiments of the present disclosure, a first association parameter is associated with a first TA. In the case that a network device transmits downlink signaling which at least carries the first association parameter, because the first association parameter corresponds to a first spatial filter, the first TA corresponding to the first spatial filter is indirectly indicated using the downlink signaling to indicate the first association parameter. In the case that the spatial filter is understood as a beam, a beam-specific TA indication is implemented, and the terminal device is capable of updating a TA value corresponding to each of different beams.

The following further describes a method for indicating TAs provided in the embodiments of the present disclosure.

FIG. 3 is a schematic diagram of a communication system according to some embodiments of the present disclosure. The communication system 300 may include a terminal device 10 and an access network device 20.

For example, the terminal device 10 is a user equipment (UE), an access terminal, a subscriber unit, a subscriber station, a mobile station, a mobile platform, a remote station, a remote terminal, a mobile device, a wireless communication device, a user agent, or a user apparatus. In some embodiments, the terminal device 10 is a cellular phone, a cordless phone, a Session Initiation Protocol (SIP) phone, a wireless local loop (WLL) station, a personal digital assistant (PDA), a handheld device with a wireless communication function, a computing device or another processing device connected to a wireless modem, a vehicle-mounted device, a wearable device, a terminal in a 5th generation (5G) mobile communication system or a future evolved public land mobile network (PLMN), or the like. The type of the terminal device 10 is not limited in the embodiments of the present disclosure. For convenience of description, the devices mentioned above are collectively referred to as the terminal.

The access network device 20 is a device deployed in an access network to provide a wireless communication function for the terminal device 10. The access network device 20 may include various forms of macro base stations, micro base stations, relay stations, access points, and the like. In systems employing different radio access technologies, a device with a function of the access network device may have different names, for example, gNodeB or gNB in a 5G NR system. As a communication technology evolves, the name “access network device” may change. For convenience of description, in the embodiments of the present disclosure, apparatuses providing the wireless communication function for the terminal device 10 are collectively referred to as the access network device. In some embodiments, a communication relationship is established between the terminal device 10 and a core network device over the access network device 20. For example, in a long-term evolution (LTE) system, the access network device 20 is an evolved universal terrestrial radio access network (EUTRAN) or one or more eNodeBs in the EUTRAN. In the 5G NR system, the access network device 20 is a radio access network (RAN) or one or more gNBs in the RAN. The network device in the embodiments of the present disclosure is the access network device 20.

The “5G NR system” in the embodiments of the present disclosure may also be referred to as a 5G system or an NR system, but a person skilled in the art can understand their meanings. The technical solutions described in the embodiments of the present disclosure may be applicable to the LTE system, the 5G NR system, or an evolved system subsequent to the 5G NR system, which is not limited in the present disclosure.

FIG. 4 illustrates a flowchart of a method for indicating TAs according to some embodiments of the present disclosure. The method is applicable in a communication system. The method includes the following processes.

In 410, a network device transmits downlink signaling to a terminal device, wherein the downlink signaling at least carries a first association parameter, the first association parameter having an association relationship with a first TA, and the first association parameter corresponding to a first spatial filter.

Accordingly, the terminal device receives the downlink signaling, the downlink signaling at least carrying the first association parameter, wherein the first association parameter has an association relationship with the first TA, and the first association parameter corresponds to the first spatial filter.

In the embodiments of the present disclosure, an association parameter, i.e., a parameter or variable in a communication system, is defined, wherein the first association parameter is an association parameter having a particular value.

The association parameter is a parameter associated with an indicator of a spatial filter, e.g., the first association parameter corresponds to the first spatial filter, and upon receiving the first association parameter, the terminal device is capable of determining that the first spatial filter is indicated.

In addition, the association parameter has an association relationship with a TA, e.g., the first association parameter has the association relationship with the first TA, and upon receiving the downlink signaling, because the downlink signaling at least carries the first association parameter, the terminal device is capable of determining, based on the association relationship between the first association parameter and the first TA, that the first TA is indicated.

For example, the downlink signaling includes at least one of: a MAC CE or a DCI.

In 420, the terminal device updates a TA of the first spatial filter based on the downlink signaling.

Upon receiving the downlink signaling, based on the indication of the downlink signaling, the terminal device determines the first spatial filter corresponding to the first association parameter based on the first association parameter carried by the downlink signaling, and updates the TA of the first spatial filter based on the first TA associated with the first association parameter.

In some embodiments, the first TA corresponds to the difference-based TA update, or the first TA corresponds to the absolute value-based TA update.

That is, the first TA is a differential value indicated to the terminal device, such that the terminal device is caused to perform the difference-based TA update for the first spatial filter by using the first TA. Alternatively, the first TA is an absolute value indicated to the terminal device, such that the terminal device is caused to perform the absolute value-based TA update for the first spatial filter using the first TA. For details about the difference-based TA update and the absolute value-based TA update, reference may be made to the above embodiments, which are not described herein any further.

From the above analysis, the first association parameter is associated with the first TA in the embodiments of the present disclosure. Because the first association parameter corresponds to the first spatial filter, the first TA corresponding to the first spatial filter is indirectly indicated using the downlink signaling to indicate the first association parameter.

In the embodiments of the present disclosure, the spatial filter is understood as a beam. It should be understood that because the first TA corresponding to the first spatial filter is indirectly indicated using downlink signaling, i.e., the first TA corresponding to a first beam is indirectly indicated, the embodiments of the present disclosure are considered as proposing a beam-specific TA update solution, such that the TA value corresponding to each of different beams is updated.

Furthermore, it should be understood that, in the case that for any TRP, a TRP association parameter of the terminal device associated with the TRP is limited to only be activated or updated with the same TA, the TRP-specific TA update solution is implemented by adding a limitation to the TRP association parameter associated with the TA. In this case, the beam-specific TA update solution is backwardly regressed into a TRP-specific TA update solution.

In summary, in the method for indicating the TA according to the embodiments of the present disclosure, the first association parameter is associated with the first TA. In the case that the network device transmits the downlink signaling and the downlink signaling at least carries the first association parameter, because the first association parameter corresponds to the first spatial filter, the first TA corresponding to the first spatial filter is indirectly indicated using the downlink signaling to indicate the first association parameter. In the case that the spatial filter is understood as a beam, the beam-specific TA indication is implemented, and the terminal device is capable of updating the TA value corresponding to each of different beams.

In some embodiments, the method is applicable to intra-cell beam management; or the method is applicable to inter-cell mobility management.

That is, the method according to the embodiments of the present disclosure is applicable to a scenario of intra-cell beam management or to a scenario of inter-cell mobility management.

For example, in the scenario of intra-cell beam management, the network device instructs, by the downlink signaling carrying the first association parameter, the terminal device to perform uplink transmission using the corresponding first spatial filter for uplink transmission. Because the first association parameter is associated with the first TA, the first TA corresponding to the first spatial filter is indirectly indicated by indicating the first association parameter, such that the beam-specific TA indication is achieved.

For example, in the scenario of inter-cell mobility management, the network device determines, based on reported beam information of the terminal device, whether the terminal device should perform cell handover, and indicates the terminal device to perform the cell handover by a handover command. The handover command triggers the terminal device to initiate a random access channel (RACH) procedure to a target cell. In the RACH procedure, the network device transmits the downlink signaling carrying the first association parameter to the terminal, wherein the first association parameter is associated with the first TA, and the first association parameter corresponds to the first spatial filter, such that the first TA corresponding to the first spatial filter is indirectly indicated by indicating the first association parameter, and the beam-specific TA indication is implemented.

In addition, the method is applicable to inter-cell management, wherein the inter-cell management includes inter-cell mobility management and inter-cell beam management.

In some embodiments, prior to indirectly indicating the first TA corresponding to the first spatial filter by the first association parameter carried in the downlink signaling, the network device needs to estimate a value of the first TA associated with the first association parameter.

Hereinafter, the manner in which the network device estimates the value of the first TA associated with the first association parameter is described in two different scenarios, i.e., the intra-cell beam management and the inter-cell mobility management.
(1) In the case that the method is applicable to the intra-cell beam management, a measurement of intra-cell SSB/CSI-RS helps the network device estimate the value of the first TA corresponding to the first association parameter, and the processes are as follows.

The terminal device determines the first TA by measuring a downlink reception time difference between a first measurement resource and a second measurement resource, and reports the first TA to the network device. The first measurement resource corresponds to the first spatial filter, and the second measurement resource is one measurement resource of a known TA value and the second measurement resource corresponds to a second spatial filter.

Accordingly, the network device receives the first TA reported by the terminal device. The terminal device determines the first TA by measuring the downlink reception time difference between the first measurement resource and the second measurement resource The first measurement resource corresponds to the first spatial filter, and the second measurement resource is one measurement resource of the known TA value and corresponds to the second spatial filter.

The measurement resource includes, but is not limited to, an SSB or a CSI-RS. The second spatial filter and the first spatial filter are two different spatial filters.

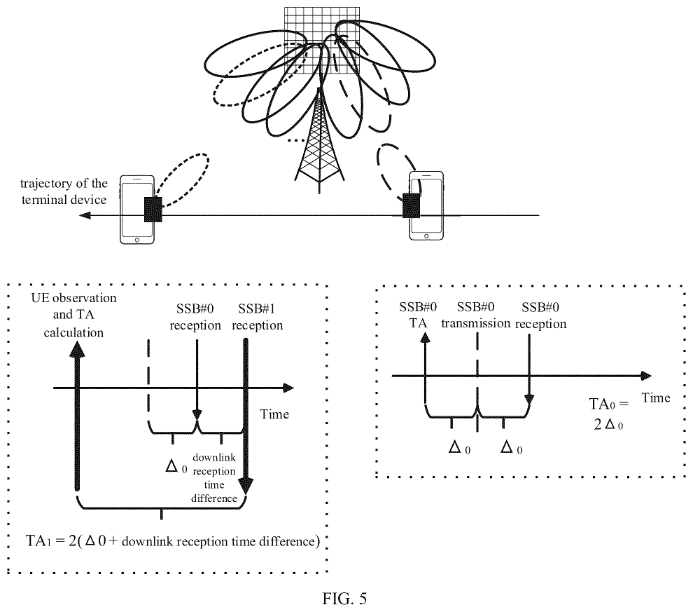

In some embodiments, with reference to FIG. 5, the first measurement resource is SSB #1and the second measurement resource is SSB #0.

The terminal device is capable of performing downlink synchronization and uplink synchronization with the SSB #0 during initial access, and the terminal device infers the TA values of different SSBs by measuring a time difference of the different SSBs (wherein downlinks of the different SSBs are synchronized with each other). The calculation formula is:

TA₁=2(Δ0+DL timing difference),

wherein Δ0 represents a TA value of half of the synchronized SSB (i.e., SSB #0), DL timing difference represents the downlink reception time difference between the two SSBs, and TAI represents a TA value of SSB #1.

In addition, in the case that the CSI-RS resource has a QCL relationship with the SSB resource, i.e., the network device uses the same beam for transmission, it is possible that the CSI-RS resource and the SSB resource correspond to the same uplink TA.
(2) In the case that the method is applicable to inter-cell mobility management, the PRACH helps the network device estimate the value of the first TA associated with the first association parameter. The processes are as follows.

The terminal device transmits the PRACH to enable the network device to determine the first TA corresponding to a neighbor cell.

Accordingly, the network device determines, over the PRACH, the first TA corresponding to the neighbor cell.

In some embodiments, in the case that the terminal device receives an activated uplink/joint TCI state, and the uplink/joint TCI state includes an SSB/CSI-RS, the terminal device is capable of transmitting a PRACH associated with the SSB/CSI-RS, that is, a receive beam of the SSB/CSI-RS is determined as a transmission beam of the PRACH at the corresponding PRACH occasion. From the perspective of time domain, a receiving time of a downlink associated SSB is taken as a reference point of an uplink transmission time of a 1st symbol of the PRACH. Upon measuring the PRACH, the network device acquires a TA value corresponding to an uplink beam.

Generally, for the neighbor cell, the terminal device only measures its SSB. However, considering that the serving cell is capable of configuring the CSI-RS resource of the neighbor cell in advance (for a purpose of mobility measurement or beam management), in the above description, CSI-RS is added to the resources that can be measured in the present disclosure, and the SSB/CSI-RS may be included in the uplink/joint TCI state for beam indication.

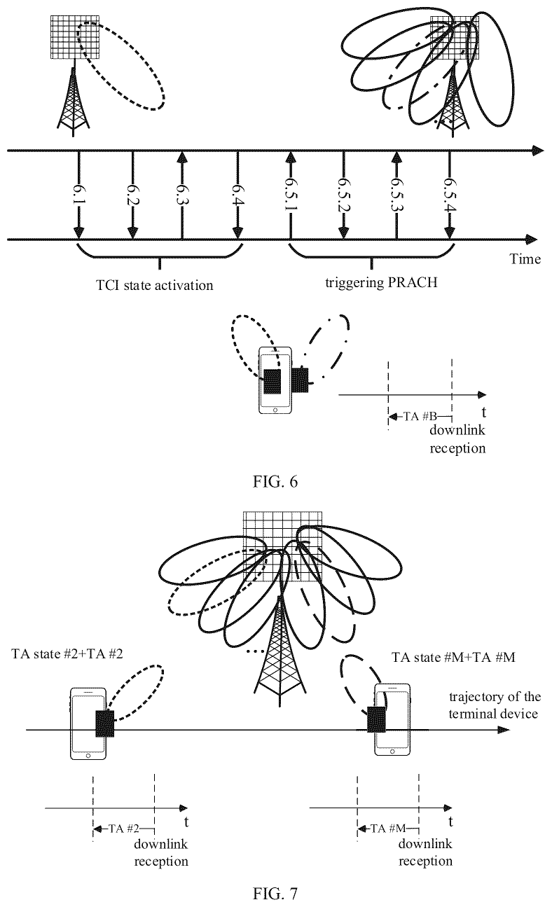

FIG. 6 illustrates a process of achieving the uplink synchronization by the network device in the neighbor cell.

In 6.1, the network device configures the inter-cell measurement for the terminal device over RRC signaling, i.e., the network device configures the SSB or the CSI-RS (for the purpose of the mobility measurement or the beam management).

In 6.2, the terminal device measures the downlink SSB or CSI-RS resources from different PCIs and acquires their quality, such as layer 1-reference signal received power (RSRP), layer 1-signal-to-noise-plus-interference ratio (SINR) or layer 1-reference signal reference signal received quality (RSRQ), or the like.

In 6.3, in the case that at least one measurement result of layer 1-RSRP, layer 1-SINR, or layer 1-RSRQ acquired from the measurement of the neighbor cell satisfies a condition for cell handover, such as layer 1-RSRP being higher than a corresponding threshold of the layer 1-RSRP, or layer 1-SINR being higher than a corresponding threshold of the layer 1-SINR, or layer 1-RSRQ being higher than a corresponding threshold of the layer 1-RSRQ, the terminal device reports the beam, including an index of an SSB or CSI-RS resource of the measured neighbor cell, a PCI to which the beam corresponds, and a beam-level quality or cell-level quality.

In 6.4, the network device transmits a cell handover command to the terminal device over layer 1 or layer 2 signaling, wherein the cell handover command triggers the terminal device to initiate a RACH procedure to an indicated target cell.

In 6.5.1, the terminal device transmits an associated PRACH to an SSB in an activated uplink/joint TCI state (wherein the cell handover command includes activation information), with the purpose of causing the network device to be capable of acquiring an uplink synchronization estimation of the terminal device in the uplink/joint TCI state.

In 6.5.2, a random access response (RAR) transmitted to the terminal device by the network device includes a TA update command of the terminal device.

In 6.5.3, the terminal device transmits Msg.3 to the network device.

In 6.5.4, the network device transmits contention resolution to the terminal device.

In some embodiments, in the case that the method is applicable to the inter-cell mobility management, the downlink signaling further includes a PCI indicator field, wherein the PCI indicator field indicates the neighbor cell.

For example, the downlink signaling is a MAC CE, and in the scenario of the inter-cell mobility management, the MAC CE includes the PCI indicator field.

In summary, the method according to the embodiments of the present disclosure is applicable to the intra-cell beam management or the inter-cell mobility management, such that beam-specific TA indication in different scenarios is implemented, and applicability of the method for indicating the TA is ensured.

In addition, in the different scenarios, the network device is capable of estimating the value of the first TA associated with the first association parameter, thereby ensuring accuracy of the beam-specific TA indication over the downlink signaling.

In some embodiments, a parameter type of the first association parameter includes a unified TCI state or an uplink power control parameter.

For example, the downlink signaling at least carries a first TCI state, wherein the first TCI state is associated with the first TA, and the first TCI state corresponds to the first spatial filter.

For example, the downlink signaling at least carries a first uplink power control parameter, wherein the first uplink power control parameter has an associative relationship with the first TA, and the first uplink power control parameter corresponds to the first spatial filter.

Therefore, in the embodiments of the present disclosure, the beam-specific TA update performed by the terminal device includes two different schemes: a TA update associated with the unified TCI state, and a TA update associated with the uplink power control parameter.

### The TA Update Associated With the Unified TCI State

It should be understood that an uplink portion of the unified TCI state includes a joint TCI state, or an uplink TCI state. Therefore, the unified TCI state in the following embodiments refers to the joint TCI state or the uplink TCI state.

In the related art, the network device uses the joint TCI state or the uplink TCI state in the unified TCI state for uplink beam indication, e.g., a plurality of serving cells share the same beam indication, and within each of the plurality of serving cells, the PUCCH, the PUSCH and the SRS (except for the non-periodic SRS used for beam management) are required to use a unified (same) uplink beam. The above characteristics are similar to the TAG-based TA indication/update supported in the relevant protocols. One TAG typically includes a plurality of serving cells, and the same TA is used for uplink channels and signals of the same TAG. For example, one TAG uses one TA (or two TAs, which are not currently supported), one TAG consists of a plurality of serving cells (i.e., CCs), and an uplink of one serving cell consists of a PUSCH, a PUCCH and an SRS.

Therefore, the embodiments of the present disclosure are designed to associate the uplink portion of the unified TCI state, i.e., the uplink TCI state and the joint TCI state, with the TA.

Furthermore, the TA update associated with the unified TCI state is applicable to the intra-cell beam management or to the inter-cell mobility management.

In some embodiments, FIG. 7 illustrates a schematic diagram of the unified TCI state associated with the TA in a single-TRP scenario. FIG. 7 shows a TA update applicable to the intra-cell beam management.

In FIG. 7, the terminal device is used in a highway or high-speed railway scenario and moves along a specific path. In the case that the terminal device moves from left to right, the network device first instructs the terminal device to use TCI state #2 (including uplink beam information) for uplink transmission and associate the TCI state #2 with TA #2. With the movement of the terminal device, the network device instructs the terminal device to use TCI state #M for uplink transmission and associate the TCI state #M with TA #M.

In addition to the scenario of the intra-cell beam management illustrated in FIG. 7, the TA update associated with the unified TCI state is also applicable to the scenario of the inter-cell mobility management.

In the case that the terminal device moves between cells, the terminal device measures the SSB resources and/or CSI-RS resources that are preconfigured by a current serving cell for the neighbor cell (dedicated to mobility measurement or beam management), and reports the beam quality of the neighbor cell (i.e., the SSB index and/or the CSI-RS resource index, and the corresponding RSRP) to the network device. Based on the reported beam information of the terminal device, the network device determines whether the terminal device should perform cell handover. For example, the condition for the cell handover is whether the RSRP of the SSB/CSI-RS of the neighbor cell is sufficiently high, i.e., whether the RSRP is higher than a preconfigured threshold. Alternatively, the condition is whether the RSRP of the SSB/CSI-RS of the neighbor cell is higher than the RSRP of the SSB/CSI-RS of the current serving cell plus a specific offset. In the case that the terminal device satisfies the condition for the cell handover, the network device activates a new neighbor cell for the terminal device to complete the inter-cell mobility management, i.e., the cell handover. With respect to a specific layer 1 or layer 2 handover command, the network device activates the unified TCI state including the SSB/CSI-RS of the neighbor cell over the MAC CE, e.g., the unified TCI state is activated for the CORESET where the PDCCH is located, or the unified TCI state is activated for the other channels, i.e., one or more unified TCI states activated by the PDSCH/PUCCH/PUSCH. The activation information of the unified TCI states described above may be included in a handover command of layer 1 or layer 2, i.e., a large and comprehensive MAC CE (including TCI state activation for the neighbor cell), and the handover command ultimately aims to make the neighbor cell a serving cell of the terminal device.

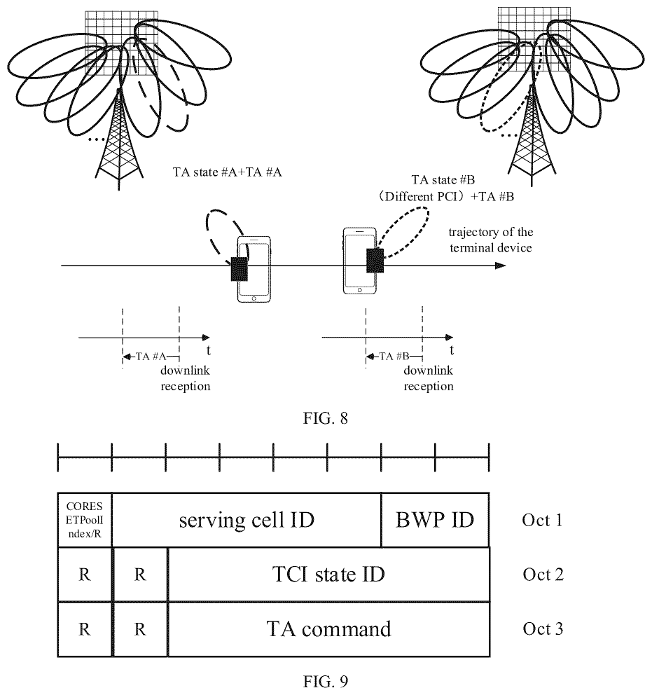

In some embodiments, FIG. 8 illustrates a schematic diagram of the unified TCI state associated with the TA in the inter-cell mobility management scenario.

In the case that the terminal device moves from left to right, the network device first instructs the terminal device to use TCI state #A (including uplink beam information) for uplink transmissions and associate to TA #A. With the movement of the terminal device, the network device instructs the terminal device to use TCI state #B for uplink transmissions and associate to TA #B, wherein the SSB/CSI-RS included in this TCI state has a PCI different from the original serving cell.

### The TA Update Associated With the Uplink Power Control Parameter

In the embodiments of the present disclosure, the uplink power control parameter includes, but is not limited to:
(1) Alpha: defining a compensation parameter for path loss in uplink power control.
(2) Path loss reference signal (PL RS): representing a downlink reference signal for path loss measurement.
(3) P0: representing a receiving power that the network device expects to receive from the uplink transmission of the terminal device.
(4) Closed loop index.

In some embodiments, the uplink power control parameter is associated with the unified TCI state in the case that the uplink power control parameter is associated with the TA.

In the relevant standard protocols, the uplink power control parameter is associated with the uplink TCI state in the unified TCI state, and the associated RRC signaling is as follows.

| UL-TCIState-r17 ::= | SEQUENCE { | |
|---|---|---|
| UL-TCIState-Id-r17 | UL-TCIState-Id-r17, | |
| servingCellId | ServCellIndex | OPTIONAL, -- Need S |

| | |
|---|---|
| referenceSignal | CHOICE { |

| | |
|---|---|
| ssb-Index | SSB-Index, |
| csi-RS-Index | NZP-CSI-RS-ResourceId, |
| srs | PUCCH-SRS |

},

| additionalPCI-r17 | AdditionalPCIIndex | OPTIONAL, -- Need R |
|---|---|---|
| ul-powerControl-r17 UL-powerControl-r17 | | OPTIONAL -- Need R |
| pathlossReferenceRS-Id | PUSCH-PathlossReferenceRS-Id | OPTIONAL -- |

Need S
}
UL-powerControl ::= SEQUENCE {

| | | |
|---|---|---|
| p0_AlphaSetforPUSCH-r17 | P0_AlphaSet-r17 | OPTIONAL, -- Need N |
| p0_AlphaSetforPUCCH-r17 | P0_AlphaSet-r17 | OPTIONAL, -- Need N |
| p0_AlphaSetforSRS-r17 | P0_AlphaSet-r17 | OPTIONAL, -- Need N |

}

| P0_AlphaSet-r17 :: | SEQUENCE { | |
|---|---|---|
| p0-r17 | INTEGER (−16..15) | OPTIONAL, -- Need R |
| alpha-r17 | Alpha | OPTIONAL, -- Need R |
| pusch-ClosedLoopIndex-r17 | ENUMERATED { i0, i1 } | |
| differentialTA | INTEGER | {0..63} OPTIONAL, -- Need R |
| absoluteTA | INTEGER | {0..3864} OPTIONAL, -- Need R |

As shown above, the uplink power control parameter is associated with the TA by adding a differential TA value and an absolute TA value to the RRC parameters of the uplink power control parameter.

Furthermore, in an exemplary association relationship as above, one UL TCI state is associated with three groups of uplink power control parameters: p0_AlphaSetforPUSCH-r17, p0_AlphaSetforPUCCH-r17, and p0_AlphaSetforSRS-r17, respectively corresponding to the PUCCH, PUSCH, and SRS.

In some embodiments, in the case that the unified TCI state is associated with at least one group of uplink power control parameters above, one group in the at least one group of uplink power control parameters has the association relationship with the TA.

That is, only one group of uplink power control parameters in the at least one group of uplink power control parameters has the association relationship with the TA.

For example, in the case that the above uplink TCI state is associated with three groups of uplink power control parameters: p0_AlphaSetforPUSCH-r17, p0_AlphaSetforPUCCH-r17, and p0_AlphaSetforSRS-r17, only p0_AlphaSetforPUSCH-r17 has the association relationship with the TA.

In some embodiments, with respect to the above situation that the unified TCI state is associated with at least one group of uplink power control parameters, in the case that a plurality of groups in the at least one group of uplink power control parameters have the association relationship with the TA, the terminal device receives an indication signaling, wherein the indication signaling is defined to activate one of the plurality of groups.

The indication signaling includes, but is not limited to, a MAC CE or a DCI.

For example, in the case that the above uplink TCI state is associated with three groups of uplink power control parameters: p0_AlphaSetforPUSCH-r17, p0_AlphaSetforPUCCH-r17, and p0_AlphaSetforSRS-r17, and the three groups of uplink power control parameters all have the association relationship with the TA, the association relationship of p0_AlphaSetforPUSCH-r17 with the TA is activated over the MAC CE.

It should be understood that by ensuring that only one group of uplink power control parameters is associated with the TA, in the case that one unified TCI state is associated with a plurality of groups of uplink power control parameters, the situation that one unified TCI state is associated with a plurality of different TAs is avoided.

In some other embodiments, the uplink power control parameter is not associated with the unified TCI state in the case that the uplink power control parameter is associated with the TA.

That is, in the case that the unified TCI state is not associated with the uplink power control parameter, the TA is also directly associated with the uplink power control parameter.

It should be understood that, for the embodiments that the uplink power control parameter is associated with the TA and the uplink power control parameter is associated with the unified TCI state, a differential TA value or an absolute TA value is defined for each of the uplink power control parameters over the RRC signaling. Although the configuration is simple, it is impossible to dynamically adjust the TA value associated with the uplink power control parameter with the movement of the terminal device (the distance to the base station changes). The embodiments that the uplink power control parameter is associated with the TA and the uplink power control parameter is not associated with the unified TCI state are more flexible.

Furthermore, in the embodiments of the present disclosure, the TA update associated with the uplink power control parameter is applicable to the intra-cell beam management or to the inter-cell mobility management.

In summary, in the method according to the embodiments of the present disclosure, two different technical solutions that the TA update is associated with the unified TCI state and the TA update is associated with the uplink power control parameter are provided, such that the flexibility of the method is enhanced.

In some embodiments, the information carried in the downlink signaling includes the following two possible situations.
(1) The downlink signaling carries the first association parameter and the first spatial filter.

In this case, process 420 is replaced by: the terminal device updates, based on the first association parameter and the first TA carried in the downlink signaling, the TA of the first spatial filter using the first TA.

In this case, the situation includes the following implementation 1 and implementation 2.

In implementation 1, the associated TA of the first association parameter includes a plurality of TAs, wherein the plurality of TAs include the first TA, and the associated TAs are predefined to have the association relationship with the first association parameter. Accordingly, the downlink signaling transmitted by the network device carries the first association parameter and the first spatial filter.

That is, in the case that a plurality of TA values are defined for each of the association parameters, the downlink signaling for indication is required to carry one association parameter and one TA value, and the terminal device is capable of determining which one of the plurality of TA values is the TA associated with the association parameter, and the TA update of the spatial filter corresponding to the association parameter is performed using the TA value.

In implementation 2, the first association parameter does not have a TA that is predefined to have the association relationship. Accordingly, the downlink signaling transmitted by the network device carries the first association parameter and the first spatial filter.

That is, in the case that the association parameter is not preconfigured with the TA value, the downlink signaling for indication needs to carry one association parameter and one TA value, and the terminal device is capable of determining the TA value associated with the association parameter, and thus the TA update of the spatial filter corresponding to the association parameter is performed using the TA value.
(2) The downlink signaling carries the first association parameter.

In this case, process 420 is replaced by: the terminal device determines, based on the first association parameter carried in the downlink signaling, the first TA that has the association relationship with the first association parameter, and updates the TA of the first spatial filter using the first TA.

In this case, the situation includes the following implementation 3.

In implementation 3, the associated TA of the first association parameter only includes the first TA, and the associated TA is predefined to have the association relationship with the first association parameter. Accordingly, the downlink signaling transmitted by the network device carries the first association parameter.

That is, in the case that only one TA value is defined for each of the association parameters, only one association parameter needs to be carried in the downlink signaling used for indication, and the terminal device is capable of determining the TA value associated with the association parameter, and thus the TA update of the spatial filter corresponding to the association parameter is performed using the TA value.

Hereinafter, the above different implementations are further described.

In the implementation 1, the associated TA of the first association parameter includes the plurality of TAs, wherein the plurality of TAs include the first TA, and the associated TAs are predefined to have the association relationship with the first association parameter. Accordingly, the downlink signaling transmitted by the network device carries the first association parameter and the first spatial filter.

In implementation 1.1, the downlink signaling is a first MAC CE, wherein the first MAC CE includes an association parameter indicator field and a TA command field, a value carried by the association parameter indicator field being a value of the first association parameter, a value carried by the TA command field being a value of the first TA.

In the present implementation, because the associated TA includes the plurality of TAs, wherein the plurality of TAs include the first TA, the network device activates one TA value (including a differential TA value and an absolute TA value) for the first association parameter over the first MAC CE.

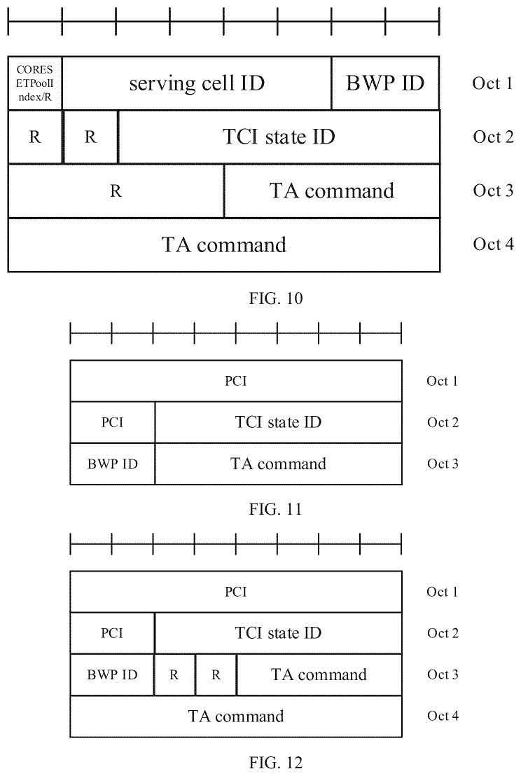

Hereinafter, the format of the first MAC CE in the scenario of the intra-cell beam management is illustrated by FIGS. 9 and 10. In FIGS. 9 and 10, a type of the first association parameter is the unified TCI state, and the association parameter indicator field is a TCI state ID field.

FIG. 9 corresponds to the activation of a differential TA value for the unified TCI state over the MAC CE. The MAC CE illustrated therein includes: the TCI state ID field and a TA command field, wherein the TA command field indicates the differential TA value.

FIG. 10 corresponds to the activation of an absolute TA value for the unified TCI state over the MAC CE. The MAC CE illustrated therein includes: the TCI state ID field and a TA command field, wherein the TA command field indicates an absolute TA value.

Furthermore, in the MAC CE illustrated in FIGS. 9 and 10, the MAC CE includes at least one of:
(1) Serving cell ID field: indicating the serving cell.
(2) Bandwidth part ID (BWP ID) field: indicating the BWP.
(3) Control resource set pool index (CORESETPoolIndex) field: indicating the TRP.

In the case that the cell is in single-TRP mode or multi-TRP mode scheduled by a single-DCI, the network device does not configure the CORESETPoolIndex for the terminal device. In this case, the MAC CE does not include the CORESETPoolIndex field, and an R field is set to 0.
(4) R field: a reserved bit.

Hereinafter, the format of the first MAC CE in the scenario of the inter-cell mobility management is illustrated in FIGS. 11 and 12. In FIGS. 11 and 12, the type of the first association parameter is the unified TCI state and the association parameter indicator field is the TCI state ID field. In this scenario, the neighbor cell has a PCI different from the current serving cell.

FIG. 11 corresponds to an activation of a differential TA value for the unified TCI state of the different PCIs over the MAC CE. The MAC CE illustrated therein includes: the TCI state ID field and a TA command field, wherein the TA command field indicates the differential TA value.

FIG. 12 corresponds to the activation of an absolute TA value for the unified TCI state of the different PCIs over the MAC CE. The MAC CE illustrated therein includes: the TCI state ID field and a TA command field, wherein the TA command field indicates the absolute TA value.

Furthermore, in the MAC CE illustrated in FIGS. 11 and 12, the MAC CE includes at least one of:
(1) PCI field: indicating the neighbor cell.
(2) BWP ID field: indicating the BWP.
(3) R field: a reserved bit.

Comparing FIG. 11 with FIG. 9, and FIG. 12 with FIG. 10, it can be seen that the MAC CE in the scenario of the inter-cell mobility management, compared to the MAC CE in the scenario of the intra-cell beam management, replaces the serving cell ID field with the PCI field.

Furthermore, FIGS. 9 to 12 only illustrate activating one TA value for one unified TCI state over one MAC CE. The embodiments of the present disclosure are also extended to activating TA values for A unified TCI states over one MAC CE, wherein A is an integer greater than 1.

Furthermore, it should be understood that in the scenario of the inter-cell mobility management, activating one TA value over one MAC CE, as illustrated above, avoids using dynamic signaling, such as a DCI, which leads to frequent cell handover, i.e., ping-pong handover.

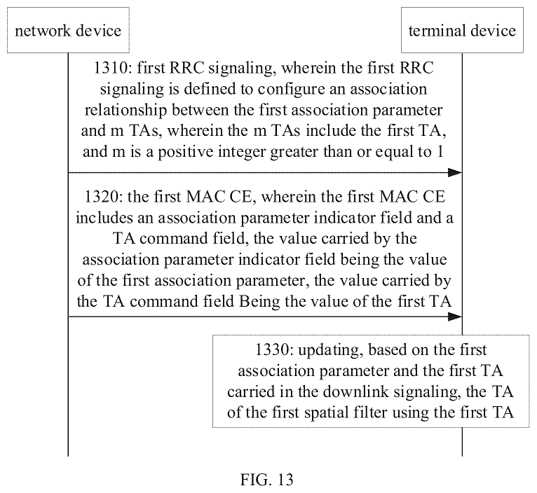

In some embodiments, prior to indicating the first MAC CE, the network device configures a plurality of TAs for the first association parameter over the first RRC signaling. The processes are referred to FIG. 13.

In 1310, the network device transmits first RRC signaling to the terminal device, wherein the first RRC signaling is defined to configure an association relationship between the first association parameter and m TAs, wherein the m TAs include the first TA, and m is a positive integer greater than or equal to 1.

Accordingly, the terminal device receives the first RRC signaling, wherein the first RRC signaling is defined to configure the association relationship between the first association parameter and the m TAs, the m TAs including the first TA, and m being a positive integer greater than or equal to 1.

In some embodiments, the type of the first association parameter is the unified TCI state, and the network device configures a plurality of TA values, such as 8, 16, 32, or 64 TA values, for the unified TCI state of the terminal device over the RRC signaling. For example, the TAs are configured in the uplink TCI state over the RRC signaling as follows.

| UL-TCIState-r17 ::= | SEQUENCE { | |
|---|---|---|
| UL-TCIState-Id-r17 | UL-TCIState-Id-r17, | |
| servingCellId | ServCellIndex | OPTIONAL, -- Need S |

| | |
|---|---|
| referenceSignal | CHOICE { |
| ssb-Index | SSB-Index, |
| csi-RS-Index | NZP-CSI-RS-ResourceId, |
| srs | PUCCH-SRS |

},

| | | |
|---|---|---|
| additionalPCI-r17 | AdditionalPCIIndex | OPTIONAL, -- Need R |
| ul-powerControl-r17 | UL-powerControl-r17 | OPTIONAL -- Need R |

| | |
|---|---|
| pathlossReferenceRS-Id | PUSCH-PathlossReferenceRS-Id OPTIONAL -- Need S |
| timingAdvance | SEQUENCE (SIZE (1..maxNroftimingadvance)) |

OF TA OPTIONAL

For difference-based TA update, only 64 defined TA values ranging from 0 to 63 are present. In the case that the terminal device supports configuring more than 64 TA values, the difference-based TA adjustment can also work without the above RRC configuration. In the case that the terminal device supports defining less than 64 TA values, the configuration is required. For example, in the case that the terminal device only supports defining 4 TA values, the network device defines 4 TA values such as [0, 15, 31, 63] for the terminal device.

For the absolute value-based TA update, the indication range of the TA is from 0 to 3864, and it is necessary to configure some specific values. For example, the defined 8 TA values are [0, 8, 16, 32, 64, 128, 256, 512].

In 1320, the network device transmits the first MAC CE to the terminal device, wherein the first MAC CE includes the association parameter indicator field and the TA command field, the value carried by the association parameter indicator field being the value of the first association parameter, the value carried by the TA command field being the value of the first TA.

Accordingly, the terminal device receives the first MAC CE, wherein the first MAC CE includes the association parameter indicator field and the TA command field, the value carried by the association parameter indicator field being the value of the first association parameter, the value carried by the TA command field being the value of the first TA.

For example, the network device configures four TA values such as [0, 15, 31, 63] for the first association parameter over the first RRC signaling, and then transmits the first MAC CE. The first MAC CE includes the association parameter indicator field and the TA command field, the value carried by the association parameter indicator field being the value of the first association parameter, the value carried by the TA command field being 31, such that one TA value 31 is activated for the first association parameter over the first MAC CE.

In 1330, the terminal device updates, based on the first association parameter and the first TA carried in the downlink signaling, the TA of the first spatial filter using the first TA.

In implementation 1.2, the downlink signaling is a first DCI, wherein the first DCI includes an association parameter indicator field and a TA indicator field, a value carried by the association parameter indicator field being a value of the first association parameter, the TA indicator field indicating the first TA; or the first DCI includes a joint encoding field, a codepoint value carried by the joint encoding field corresponding to the first association parameter and the first TA.

In the present implementation, because the associated TA includes a plurality of TAS, wherein the plurality of TAs include the first TA, the network device is capable of activating one TA value (including a differential TA value and an absolute TA value) for the first association parameter over the first DCI.

The first DCI is implemented in any one of the following two forms.

The first DCI includes the association parameter indicator field and the TA indicator field, wherein the value carried by the association parameter indicator field is the value of the first association parameter, and the TA indicator field indicates the first TA.

For example, the DCI format 1_1/1/1_2 without DL grant includes: the TCI state ID field and the TA indicator field. The TCI state ID field indicates a first TCI state, and the TA indicator field indicates one TA in the TAs associated with the indicated first TCI state. For example, in the case that 4 TAs are associated with the indicated first TCI state, the TA indicator field includes 2 bits with the states ‘00,’ ‘01,’ ‘10,’ and ‘1l’ respectively representing the 1^{st}, 2^{nd}, 3^{rd}, and 4^{th} TA values associated with the first TCI state.

The first DCI includes the joint encoding field, wherein the codepoint value carried by the joint encoding field corresponds to the first association parameter and the first TA.

In some embodiments, DCI format 1_1/1/1_2 (with or without DL grant) includes the joint encoding field, wherein the joint encoding field may be implemented using an existing information field in the DCI format, and the joint encoding field dynamically indicates information of the first association parameter and the first TA. For example, the first 3 bits in one information field indicate the TCI state ID, and the last 2 bits indicate the TA associated with the indicated TCI state, e.g., ‘001’ in a codepoint ‘00110’ represents a 2nd TCI state being indicated, and ‘10’ in the codepoint represents a 3^{rd} TA associated with the TCI state is indicated.

In some embodiments, prior to indicating the first DCI, the network device configures a plurality of TAs for the first association parameter over second RRC signaling and a second MAC CE. The processes are referred to FIG. 14.

In 1410, the network device transmits the second RRC signaling to the terminal device, wherein the second RRC signaling is defined to configure an association relationship between the first association parameter and m TAs, m being a positive integer greater than or equal to 1.

Accordingly, the terminal device receives the second RRC signaling, wherein the second RRC signaling is defined to configure the association relationship between the first association parameter and the m TAs.

For the specific implementation of configuring the plurality of TA values for the first association parameter over the second RRC signaling, reference may be made to process 1310, which is not described herein any further.

In 1420, the network device transmits the second MAC CE to the terminal device, wherein the second MAC CE is defined to activate n TAs in the m TAs for the first association parameter, the n TAs including the first TA, and n being a positive integer greater than or equal to 1.

Accordingly, the terminal device receives the second MAC CE, the second MAC CE being defined to activate the n TAs in the m TAs for the first association parameter, wherein the n TAs includes the first TA.

That is, based on configuring the plurality of TA values over the second RRC signaling, some of the TA values are activated for the first association parameter over the second MAC CE.

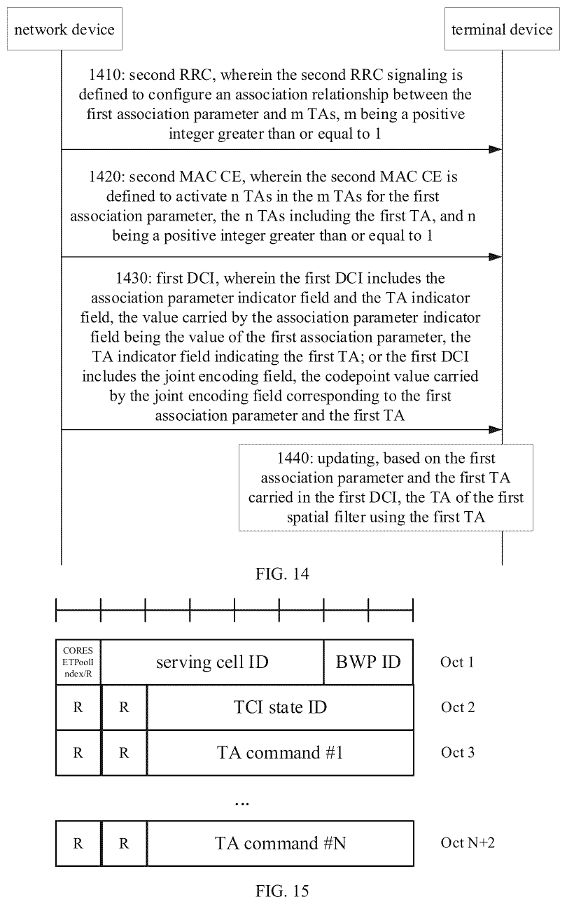

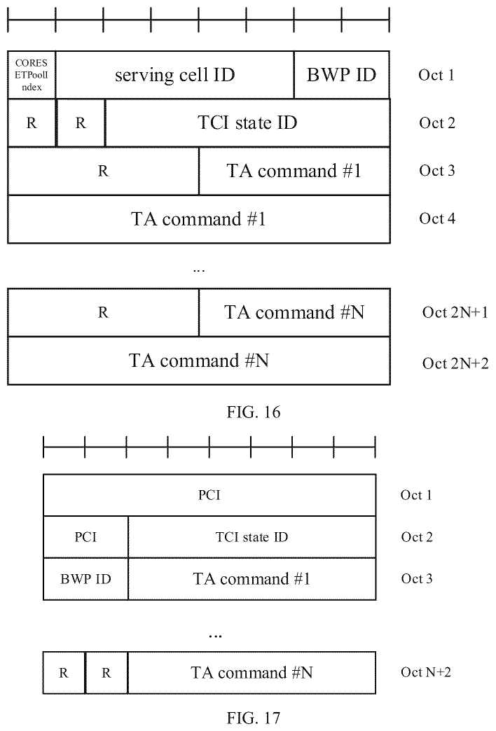

Hereinafter, the format of the second MAC CE in the scenario of the intra-cell beam management is illustrated by FIGS. 15 and 16. In FIGS. 15 and 16, the type of the first association parameter is the unified TCI state and the association parameter indicator field is the TCI state ID field.

FIG. 15 corresponds to activations of N differential TA values for the unified TCI state over the MAC CE. The MAC CE illustrated therein includes: one TCI state field ID and N TA command fields, wherein the N TA command fields indicate the N differential TA values.

FIG. 16 corresponds to activations of N absolute TA values for the unified TCI state over the MAC CE. The MAC CE illustrated therein includes: one TCI state ID field and N TA command fields, wherein the N TA command fields indicate the N absolute TA values.

Furthermore, in the MAC CE illustrated in FIGS. 15 and 16, the MAC CE includes at least one of:
(1) Serving cell ID field: indicating the serving cell.
(2) BWP ID field: indicating the BWP.
(3) CORESETPoolIndex field: indicating the TRP.

In the case that the cell is in the single-TRP mode or the multi-TRP mode scheduled by the single-DCI, the network device does not configure the CORESETPoolIndex for the terminal device. In this case, the MAC CE does not include the CORESETPoolIndex field, and an R field is set to 0.
(4) R field: a reserved bit.

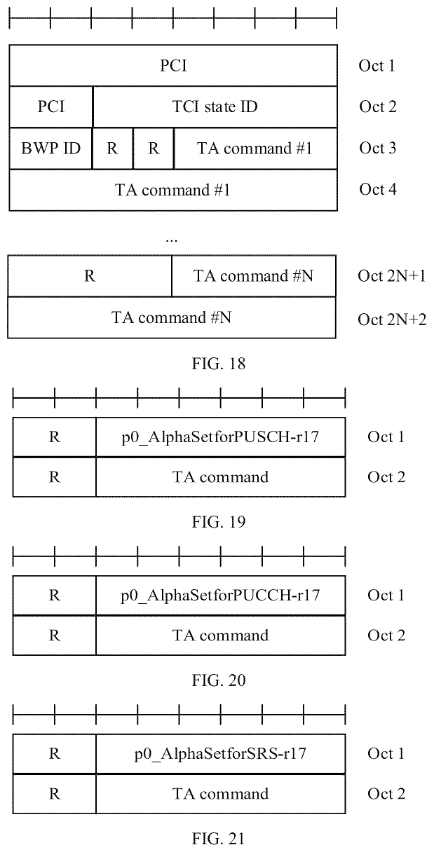

Hereinafter, the format of the second MAC CE in the scenario of the inter-cell mobility management is illustrated in FIGS. 17 and 18. In FIGS. 17 and 18, the type of the first association parameter is the unified TCI state and the association parameter indicator field is the TCI state ID field. In this scenario, the neighbor cell has a PCI different from the current serving cell.

FIG. 17 corresponds to activations of N differential TA values for the unified TCI state of the different PCIs over the MAC CE. The MAC CE illustrated therein includes: one TCI state ID field and N TA command fields, wherein the N TA command fields indicate the N differential TA values.

FIG. 18 corresponds to activations of N absolute TA values for the unified TCI states of the different PCIs over the MAC CE. The MAC CE illustrated therein includes: one TCI state ID field and N TA command fields, wherein the N TA command fields indicate the N absolute TA values.

Furthermore, in the MAC CE illustrated in FIGS. 17 and 18, the MAC CE includes at least one of:
(1) PCI field: indicating the neighbor cell.
(2) BWP ID field: indicating the BWP.
(3) R field: a reserved bit.

Comparing FIG. 17 with FIG. 15, and FIG. 18 with FIG. 16, it can be seen that the MAC CE in the scenario of the inter-cell mobility management, compared to the MAC CE in the scenario of the intra-cell beam management, replaces the serving cell ID field with the PCI field.

In addition, FIGS. 15 to 18 only illustrate activations of N TA values for one unified TCI state over one MAC CE. The embodiments of the present disclosure are also extended to activations of A*N TA values for A unified TCI states over one MAC CE, wherein A and N are integers greater than 1.

In 1430, the network device transmits the first DCI to the terminal device, wherein the first DCI includes the association parameter indicator field and the TA indicator field, the value carried by the association parameter indicator field being the value of the first association parameter, the TA indicator field indicating the first TA; or the first DCI includes the joint encoding field, the codepoint value carried by the joint encoding field corresponding to the first association parameter and the first TA.

Accordingly, the terminal device receives the first DCI, wherein the first DCI includes the association parameter indicator field and the TA indicator field, the value carried by the association parameter indicator field being the value of the first association parameter, the TA indicator field indicating the first TA; or the first DCI includes the joint encoding field, the codepoint value carried by the joint encoding field corresponding to the first association parameter and the first TA.

In 1440, the terminal device updates, based on the first association parameter and the first TA carried in the first DCI, the TA of the first spatial filter using the first TA.

In some embodiments, upon the terminal device receiving the first DCI, the first TA associated with the first association parameter takes effect upon the beam indication taking effect.

The process of the beam indication taking effect is categorized into two situations.

In situation 1, the first DCI includes downlink scheduling information. The terminal device, upon receiving the scheduled PDSCH, feeds back a hybrid automatic repeat request (HARQ) message for the PDSCH to the network device. Then, in the case that the next slot upon a certain beam application time (BAT) time is passed, the newly indicated beam is considered to be in effect, that is, the TA associated with the newly indicated beam is in effect. The BAT generally includes several orthogonal frequency division multiplexing (OFDM) symbols.

In situation 2, the first DCI does not include downlink scheduling information, that is, no real PDSCH transmission is present, and the purpose of the DCI is only to provide an update of the beam. The terminal device performs a HARQ feedback for the DCI. Then, in the case that the next slot upon a certain BAT is passed, the newly indicated beam considered to be in effect, that is, the TA associated with the newly indicated beam is in effect.

In summary, in the method according to the embodiments of the present disclosure, in the case that the plurality of TA values are defined for each of the association parameters, the downlink signaling for indication is required to carry one association parameter and one TA value, and the terminal device is capable of determining which one of the plurality of TA values is the TA value associated with the association parameter, and the TA update of the spatial filter corresponding to the association parameter is performed by using the TA value, such that the beam-specific TA update is implemented.

Meanwhile, in the method according to the embodiments of the present disclosure, the downlink signaling may be implemented as the MAC CE, such that frequent cell handover caused by using dynamic signaling in certain scenarios is avoided.

Meanwhile, in the method according to the embodiments of the present disclosure, the downlink signaling may be implemented as the DCI, and more flexible indication with a smaller delay is carried out by using the DCI.

In the implementation 2, the first association parameter does not have the TA preconfigured with the association relationship. Accordingly, and the downlink signaling transmitted by the network device carries the first association parameter and the first spatial filter.

In implementation 2.1, the downlink signaling is a third MAC CE, wherein the third MAC CE is defined to configure the association relationship between the first association parameter and the first TA.

In this implementation, because the first association parameter is not preconfigured to have an associated TA, the network device associates the first TA (including a differential TA value and an absolute TA value with the first association parameter over the third MAC CE.

Hereinafter, the format of the third MAC CE is illustrated by FIGS. 19 to 21. In FIGS. 19 to 21, the type of the first association parameter is the uplink power control parameter.

Referring to FIG. 19, the MAC CE includes: a p0_AlphaSetforPUSCH-r17 field and the TA command field, wherein the p0_AlphaSetforPUSCH-r17 field indicates the p0_AlphaSetforPUSCH-r17 and the TA command field indicates the first TA.

Referring to FIG. 20, the MAC CE includes: a p0_AlphaSetforPUCCH-r17 field and the TA command field, wherein the p0_AlphaSetforPUCCH-r17 field indicates p0_AlphaSetforPUCCH-r17 and the TA command field indicates the first TA.

Referring to FIG. 21, the MAC CE includes: a p0_AlphaSetforSRS-r17 field and the TA command field, wherein the p0_AlphaSetforSRS-r17 field indicates p0_AlphaSetforSRS-r17 and the TA command field indicates the first TA.

Furthermore, the structure of the MAC CE illustrated in above FIGS. 19 to 21 is only for difference-based TA update, and the number of uplink power control parameters in the set of uplink power control parameters is assumed to be 64, such that the uplink power control parameter field in the MAC CE occupies 6 bits. In addition, for the absolute value-based TA update, the TA command field in the MAC CE may be extended from 6 bits to 12 bits.

In addition, the format of the third MAC CE illustrated in FIGS. 19 to 21 is applicable to the scenario of the intra-cell beam management or the scenario of the inter-cell mobility management.

In summary, in the method according to the embodiments of the present disclosure, in the case that the association parameter is not preconfigured with the TA, the downlink signaling for indication is required to carry one association parameter and one TA value, and the terminal device is capable of determining the TA value associated with the association parameter, thus the TA update of the spatial filter corresponding to the association parameter is performed by using the TA value, such that the beam-specific TA update is implemented.

Meanwhile, in the method according to the embodiments of the present disclosure, the downlink signaling may be implemented as the MAC CE, such that frequent cell handover caused by using the dynamic signaling in some scenarios is avoided.

In the implementation 3, the associated TA of the first association parameter only includes the first TA, and the associated TA is preconfigured an association relationship with the first association parameter. Accordingly, the downlink signaling transmitted by the network device carries the first association parameter.

In implementation 3.1, the downlink signaling is a second DCI, wherein the second DCI includes an association parameter indicator field, a value carried by the association parameter indicator field being the value of the first association parameter.

In this implementation, because the associated TA only includes the first TA, the network device is capable of indicating the first association parameter by the second DCI, and because the first association parameter is associated with the first TA, the first TA (including the differential TA value and the absolute TA value) is indirectly indicated.

In some embodiments, the type of the first association parameter is the uplink power control parameter.

For example, in DCI format 2-2, a power control command indicating the PUCCH and the PUSCH of the terminal device is provided to the terminal device by the network device, wherein the power control command includes a 1-bit closed-loop power control indication index and a 2-bit power control adjustment, i.e., to increase or decrease a certain amount of transmit power. The terminal device then determines the TA value associated with the terminal device and performs a TA update of the corresponding spatial filter by using the TA value.

For example, in DCI format 2-3, a power control command indicating the SRS of the terminal device is provided to the terminal device by the network device, wherein the power control command includes one SRS request and a 2-bit power control adjustment, i.e., to increase or decrease a certain amount of transmit power. The terminal device then determines a TA value associated with the terminal device and performs a TA update of the corresponding spatial filter by using the TA value.

In some embodiments, the type of the first association parameter is the unified TCI state.

For example, in the DCI, the unified TCI state field already exists and the unified TCI state is associated with an exact TA. Therefore, the DCI achieves indication of the TA associated with the unified TCI state while indicating the unified TCI state simultaneously, and a TA update of the corresponding spatial filter is performed by using the TA value.

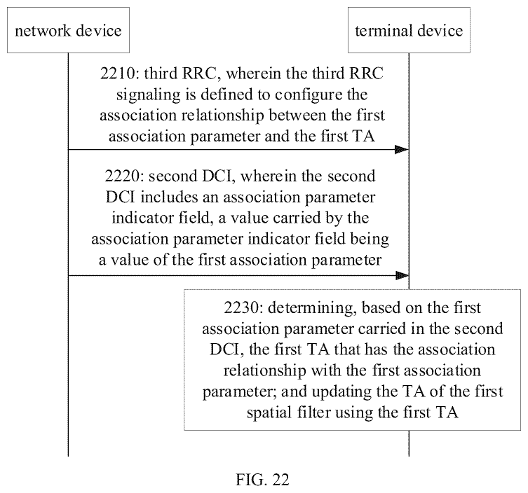

In some embodiments, prior to indicating the second DCI, the network device configures one TA for the first association parameter over third RRC signaling. For specific processes, reference may be made to FIG. 22.

In 2210, the network device transmits the third RRC signaling to the terminal device, wherein the third RRC signaling is defined to configure the association relationship between the first association parameter and the first TA.

Correspondingly, the terminal device receives the third RRC signaling, wherein the third RRC signaling is defined to configure the association relationship between the first association parameter and the first TA.

For details about the specific implementation of configuring one TA value for the first association parameter over the third RRC signaling, reference may be made to process 1310, which are not described herein any further.

In 2220, the network device transmits a second DCI to the terminal device, wherein the second DCI includes an association parameter indicator field, a value carried by the association parameter indicator field being the value of the first association parameter.

Accordingly, the terminal device receives the second DCI, wherein the second DCI includes the association parameter indicator field. The value carried by the association parameter indicator field is the value of the first association parameter.

In 2230, the terminal device determines, based on the first association parameter carried in the second DCI, the first TA that has the association relationship with the first association parameter; and updates the TA of the first spatial filter using the first TA.

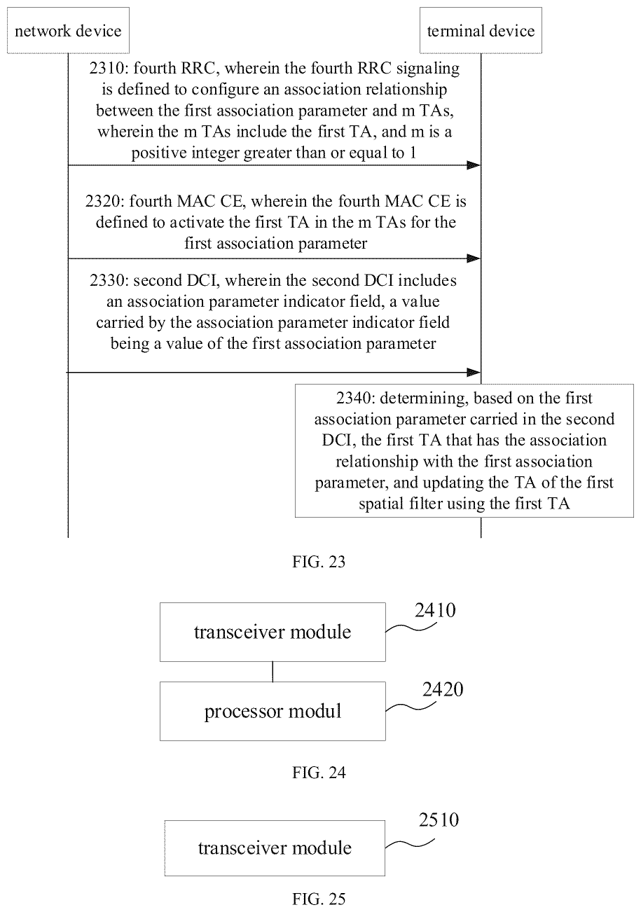

In some embodiments, prior to indicating the second DCI, the network device configures a plurality of TAs for the first association parameter over fourth RRC signaling, and then activates one TA for the first association parameter over a fourth MAC CE. The processes are referred to FIG. 23.

In 2310, the network device transmits the fourth RRC signaling to the terminal device, wherein the fourth RRC signaling is defined to configure an association relationship between the first association parameter and m TAs, wherein the m TAs include the first TA, and m is a positive integer greater than or equal to 1.

Accordingly, the terminal device receives the fourth RRC signaling, wherein the fourth RRC signaling is defined to configure the association relationship between the first association parameter and the m TAs, wherein the m TAs include the first TA, and m is a positive integer greater than or equal to 1.

For details about the specific implementation of configuring one TA value for the first association parameter over the fourth RRC signaling, reference may be made to process 1310, which are not described herein any further.

In 2320, the network device transmits a fourth MAC CE to the terminal device, wherein the fourth MAC CE is defined to activate the first TA in the m TAs for the first association parameter.

Accordingly, the terminal device receives the fourth MAC CE, wherein the fourth MAC CE is defined to activate the first TA in the m TAs for the first association parameter.

That is, based on configuring a plurality of TA values over the fourth RRC signaling, one of the plurality of TA values is activated for the first association parameter over the fourth MAC CE.

For details about the format of the fourth MAC CE, reference may be made to FIGS. 8 to 11, which are not described herein any further.

In 2330, the network device transmits a second DCI to the terminal device, wherein the second DCI includes an association parameter indicator field, a value carried by the association parameter indicator field being the value of the first association parameter.

Accordingly, the terminal device receives the second DCI, wherein the second DCI includes the association parameter indicator field. The value carried by the association parameter indicator field is the value of the first association parameter.

In 2340, the terminal device determines, based on the first association parameter carried in the second DCI, the first TA that has the association relationship with the first association parameter, and updates the TA of the first spatial filter using the first TA.

It should be understood, in conjunction with comparing the technical solutions illustrated in FIGS. 22 and 23, in the case that the network device configures only one TA value for one association parameter (whether an absolute TA value or a differential TA value), the subsequent TA activation process can be skipped, and the TA is directly associated with the association parameter to which the TA belongs, and the TA is used directly in the dynamic indication of the DCI.

In some embodiments, upon the terminal device receiving the first DCI, the first TA associated with the first association parameter takes effect upon the beam indication taking effect.

The process of the beam indication taking effect is categorized into two situations.

In situation 1, the second DCI includes downlink scheduling information. The terminal device, upon receiving the scheduled PDSCH, feeds one HARQ message for the PDSCH back to the network device. Then, in the case that the next slot upon a certain BAT is passed, the newly indicated beam is considered to be in effect, that is, the TA associated with the newly indicated beam is in effect. The BAT generally includes several OFDM symbols.

In situation 2, the second DCI does not include downlink scheduling information, that is, no real PDSCH transmission is present, and the purpose of the DCI is only to provide an update of the beam. The terminal device performs a HARQ feedback for the DCI. Then, in the case that the slot upon a certain BAT is passed, the newly indicated beam considered to be in effect, that is, the TA associated with the newly indicated beam is in effect.

In summary, in the method according to the embodiments of the present disclosure, in the case that only one TA value is defined for each of the association parameters, the downlink signaling for indication is only required to carry one beam association parameter, and the terminal device is capable of determining the TA value associated with the association parameter, the TA update of the spatial filter corresponding to the association parameter is performed using the TA value, such that the beam-specific TA update is implemented.

Meanwhile, in the method according to the embodiments of the present disclosure, the downlink signaling may be implemented as the DCI, such that more flexible indication with a smaller delay can be carried out using the DCI.

It should be noted that the above method embodiments are performed individually or in combination, which is not limited in the present disclosure.

FIG. 24 illustrates a structural block diagram of an apparatus for a TA according to some embodiments of the present disclosure. The apparatus is implemented as a terminal device or a portion of a terminal device. The apparatus includes a transceiver module 2410 and a processor module 2420.

The transceiver module 2410 is configured to receive downlink signaling, wherein the downlink signaling at least carries a first association parameter, the first association parameter having an association relationship with a first TA, and the first association parameter corresponding to a first spatial filter.

The processor module 2420 is configured to update a TA of the first spatial filter based on the downlink signaling.

In some embodiments, the downlink signaling carries the first association parameter and the first spatial filter; or the downlink signaling carries the first association parameter.

In some embodiments, in the case that the downlink signaling carries the first association parameter and the first spatial filter, an associated TA of the first association parameter includes a plurality of TAs, wherein the plurality of TAs include the first TA, and the associated TA is preconfigured with the association relationship with the first association parameter.

In some embodiments, the downlink signaling is a first MAC CE, wherein the first MAC CE includes an association parameter indicator field and a TA command field, a value carried by the association parameter indicator field being a value of the first association parameter, a value carried by the TA command field being a value of the first TA.

In some embodiments, the transceiver module 2410 is configured to receive first RRC signaling, wherein the first RRC signaling is defined to configure an association relationship between the first association parameter and m TAs, wherein the m TAs include the first TA, and m is a positive integer greater than or equal to 1.

In some embodiments, the downlink signaling is a first DCI, wherein the first DCI includes an association parameter indicator field and a TA indicator field, a value carried by the association parameter indicator field being the value of the first association parameter, the TA indicator field indicating the first TA; or the first DCI includes a joint encoding field, a codepoint value carried by the joint encoding field corresponding to the first association parameter and the first TA.

In some embodiments, the transceiver module 2410 is configured to receive second RRC signaling, wherein the second RRC signaling is defined to configure an association relationship between the first association parameter and m TAs; and the transceiver module 2410 is configured to receive a second MAC CE, wherein the second MAC CE is defined to activate n TAs in the m TAs for the first association parameter, wherein the n TAs include the first TA, and m and n are positive integers greater than or equal to 1.

In some embodiments, in the case that the downlink signaling carries the first association parameter and the first spatial filter, the first association parameter does not have a TA preconfigured with the association relationship.

In some embodiments, the downlink signaling is a third MAC CE, wherein the third MAC CE is defined to configure the association relationship between the first association parameter and the first TA.

In some embodiments, in the case that the downlink signaling carries the first association parameter, an associated TA of the first association parameter only includes the first TA, and the associated TA is predefined to have the association relationship with the first association parameter.

In some embodiments, the downlink signaling is a second DCI, wherein the second DCI includes an association parameter indicator field, a value carried by the association parameter indicator field being the value of the first association parameter.

In some embodiments, the transceiver module 2410 is configured to receive third RRC signaling, wherein the third RRC signaling is defined to configure the association relationship between the first association parameter and the first TA.

In some embodiments, the transceiver module 2410 is configured to receive fourth RRC signaling, wherein the fourth RRC signaling is defined to configure an association relationship between the first association parameter and m TAs, wherein the m TAs include the first TA, and m is a positive integer greater than or equal to 1; and the transceiver module 2410 is configured to receive a fourth MAC CE, wherein the fourth MAC CE is defined to activate the first TA in the m TAs for the first association parameter.

In some embodiments, a parameter type of the first association parameter includes: a unified TCI state; or an uplink power control parameter.

In some embodiments, the uplink power control parameter is associated with the unified TCI state; or the uplink power control parameter is not associated with the unified TCI state.

In some embodiments, in the case that the uplink power control parameter is associated with the unified TCI state, the unified TCI state is associated with at least one group of uplink power control parameters, wherein one group in the at least one group of uplink power control parameters has the association relationship with a TA.

In some embodiments, in the case that the uplink power control parameter is associated with the unified TCI state, the unified TCI state is associated with at least one group of uplink power control parameters; and the transceiver module 2410 is configured to receive indication signaling in the case that a plurality of groups in the at least one group of uplink power control parameters have the association relationship with the TA, wherein the indication signaling is defined to activate one of the plurality of groups.

In some embodiments, the method for indicating the TA is applicable to intra-cell beam management; or the method for indicating the TA is applicable to inter-cell mobility management.

In some embodiments, in the case that the method for indicating the TA is applicable to the inter-cell mobility management, the downlink signaling further includes a PCI indicator field, wherein the PCI indicator field indicates a neighbor cell.

In some embodiments, in the case that the method for indicating the TA is applicable to the intra-cell beam management, the processor module 2420 is configured to determine the first TA by measuring a downlink reception time difference between a first measurement resource and a second measurement resource, and the transceiver module 2410 is configured to transmit the first TA to a network device, wherein the first measurement resource corresponds to the first spatial filter, the second measurement resource is one measurement resource of a known TA value, and the second measurement resource corresponds to a second spatial filter.

In some embodiments, in the case that the method for indicating the TA is applicable to the inter-cell mobility management, the transceiver module 2410 is configured to transmit a PRACH to cause the network device to determine the first TA corresponding to a neighbor cell.

In some embodiments, the first TA corresponds to difference-based TA update, or the first TA corresponds to absolute value-based TA update.

FIG. 25 illustrates a structural block diagram of an apparatus for indicating a TA according to some embodiments of the present disclosure. The apparatus is implemented as a network device or a portion of a network device. The apparatus includes a transceiver module 2510.

The transceiver module 2510 is configured to transmit downlink signaling, wherein the downlink signaling at least carries a first association parameter, the first association parameter having an association relationship with a first TA, the first association parameter corresponding to a first spatial filter; wherein the downlink signaling is defined for the terminal device to update a TA of the first spatial filter.

In some embodiments, the downlink signaling carries the first association parameter and the first spatial filter; or the downlink signaling carries the first association parameter.

In some embodiments, in the case that the downlink signaling carries the first association parameter and the first spatial filter, an associated TA of the first association parameter includes a plurality of TAs, wherein the plurality of TAs include the first TA, and the associated TA is predefined to have the association relationship with the first association parameter.

In some embodiments, the downlink signaling is a first MAC CE, wherein the first MAC CE includes an association parameter indicator field and a TA command field, a value carried by the association parameter indicator field being a value of the first association parameter, a value carried by the TA command field being a value of the first TA.

In some embodiments, the transceiver module 2510 is configured to transmit first RRC signaling, wherein the first RRC signaling is defined to configure an association relationship between the first association parameter and m TAs, wherein the m TAs include the first TA, and m is a positive integer greater than or equal to 1.

In some embodiments, the downlink signaling is a first DCI, wherein the first DCI includes an association parameter indicator field and a TA indicator field, a value carried by the association parameter indicator field being value of the first association parameter, and the TA indicator field indicating the first TA; or the first DCI includes a joint encoding field, a codepoint value carried by the joint encoding field corresponding to the first association parameter and the first TA.

In some embodiments, the transceiver module 2510 is configured to transmit second RRC signaling, wherein the second RRC signaling is defined to configure an association relationship between the first association parameter and m TAs; and the transceiver module 2510 is configured to transmit a second MAC CE, wherein the second MAC CE is defined to activate n TAs in the m TAs for the first association parameter, wherein the n TAs include the first TA, and m and n are positive integers greater than or equal to 1.

In some embodiments, in the case that the downlink signaling carries the first association parameter and the first spatial filter, the first association parameter does not have a TA preconfigured with the association relationship.

In some embodiments, the downlink signaling is a third MAC CE, wherein the third MAC CE is defined to configure the association relationship between the first association parameter and the first TA.

In some embodiments, in the case that the downlink signaling carries the first association parameter, an associated TA of the first association parameter only includes the first TA, wherein the associated TA is predefined to have the association relationship with the first association parameter.

In some embodiments, the downlink signaling is a second DCI, wherein the second DCI includes an association parameter indicator field, a value carried by the association parameter indicator field being the value of the first association parameter.

In some embodiments, the transceiver module 2510 is configured to transmit third RRC signaling, wherein the third RRC signaling is defined to configure the association relationship between the first association parameter and the first TA.

In some embodiments, the transceiver module 2510 is configured to transmit fourth RRC signaling, wherein the fourth RRC signaling is defined to configure an association relationship between the first association parameter and m TAs, wherein the m TAs include the first TA, and m is a positive integer greater than or equal to 1; and the transceiver module 2510 is configured to transmit a fourth MAC CE, wherein the fourth MAC CE is defined to activate the first TA in the m TAs for the first association parameter.

In some embodiments, a parameter type of the first association parameter includes: a unified TCI state; or an uplink power control parameter.

In some embodiments, the uplink power control parameter is associated with the unified TCI state; or the uplink power control parameter is not associated with the unified TCI state.

In some embodiments, in the case that the uplink power control parameter is associated with the unified TCI state, the unified TCI state is associated with at least one group of uplink power control parameters, wherein one group in the at least one group of uplink power control parameters has the association relationship with a TA.

In some embodiments, in the case that the uplink power control parameter is associated with the unified TCI state, the unified TCI state is associated with at least one group of uplink power control parameters; and the transceiver module 2510 is configured to transmit indication signaling in the case that a plurality of groups in the at least one group of uplink power control parameters have the association relationship with the TA, wherein the indication signaling is defined to activate one of the plurality of groups.

In some embodiments, the method for indicating the TA is applicable to intra-cell beam management; or the method for indicating the TA is applicable to inter-cell mobility management.

In some embodiments, in the case that the method for indicating the TA is applicable to the inter-cell mobility management, the downlink signaling further includes a PCI indicator field, the PCI indicator field indicating a neighbor cell.

In some embodiments, in the case that the method for indicating the TA is applicable to the intra-cell beam management, the transceiver module 2510 is configured to receive the first TA reported by a terminal device, wherein the first TA is determined by the terminal device measuring a downlink reception time difference between a first measurement resource and a second measurement resource, the first measurement resource corresponding to the first spatial filter, the second measurement resource being one measurement resource of a known TA value, and the second measurement resource corresponding to a second spatial filter.

In some embodiments, in the case that the method for indicating the TA is applicable to the inter-cell mobility management, the apparatus further includes a processor module, wherein the processor module is configured to determine the first TA corresponding to a neighbor cell over a PRACH.

In some embodiments, the first TA corresponds to difference-based TA update, or the first TA corresponds to absolute value-based TA update.

It should be noted that in the case that the apparatus provided in the foregoing embodiments performs its functions, division of the functional modules is merely used as an example. In practice, the foregoing functions may be allocated to and completed by different functional modules as required, that is, an internal structure of the apparatus is divided into different functional modules to complete all or some of the foregoing functions.

Specific manners of performing operations by the modules in the apparatus in the foregoing embodiments have been described in detail in the embodiments of the related method, which are not described herein any further.

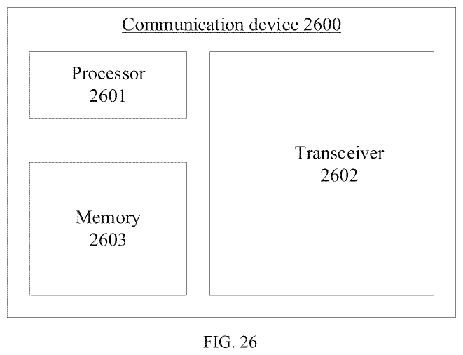

FIG. 26 is a schematic structural diagram of a communication device (terminal device or network device) according to some embodiments of the present disclosure. The communication device 2600 includes a processor 2601, a transceiver 2602, and a memory 2603.

The processor 2601 includes one or more processing cores. The processor 2601 runs a software program and module to execute various functional applications.

The transceiver 2602 may be configured to receive and transmit information. The transceiver 2602 may be a communication chip.

The memory 2603 may be configured to store at least one computer program. The processor 2601, when loading and running the at least one computer program, is caused to perform each process performed by the communication device in the method embodiments.

In addition, the memory 2603 may be implemented by any type of volatile or non-volatile storage device or a combination thereof. The volatile or non-volatile storage device includes but is not limited to a random-access memory (RAM), a read-only memory (ROM), an erasable programmable ROM (EPROM), an electrically EPROM (EEPROM), a flash memory or another solid-state storage technology, a compact disc ROM (CD-ROM), a high-density digital video disc (DVD) or another optical memory, a magnetic tape cartridge, a magnetic tape, a disk memory, or another magnetic memory device.

The processor 2601 and the transceiver 2602 involved in the embodiments of the present disclosure may perform the processes performed by the terminal device in any method illustrated in the foregoing embodiments, which are not described herein any further.

In some embodiments, the transceiver 2602 is configured to receive downlink signaling, wherein the downlink signaling at least carries a first association parameter, wherein the first association parameter has an association relationship with a first TA, and the first association parameter corresponds to a first spatial filter.

The processor 2601 is configured to update a TA of the first spatial filter based on the downlink signaling.

The processor 2601 and the transceiver 2602 in the embodiments of the present disclosure performs the processes performed by the network device in any of the above method embodiments, which are not described herein any further.

In some embodiments, the transceiver 2602 is configured to transmit downlink signaling, wherein the downlink signaling at least carries a first association parameter, the first association parameter having an association relationship with a first TA, and the first association parameter corresponding to a first spatial filter; wherein the downlink signaling is configured for the terminal device to update a TA of the first spatial filter.

In some embodiments, a non-transitory computer-readable storage medium is further provided. The non-transitory computer-readable storage medium stores at least one instruction, at least one program, a code set, or an instruction set. The at least one instruction, the at least one program, the code set, or the instruction set, when loaded and executed by a processor, causes the processor to perform the method according to the method embodiments.

In some embodiments, a chip is further provided. The chip includes a programmable logic circuit and/or a program instruction. When running on a terminal device or network device, the chip performs the method according to the above aspects.

In some embodiments, a computer program product is further provided. When running on a processor of a computer device, the computer program product is configured to perform the method as described above.

Those of ordinary skill in the art can understand that all or some of the processes in the foregoing embodiments may be performed by hardware, or by instructing related hardware by using a program. The program may be stored in a non-transitory computer-readable storage medium. The storage medium may be a read-only memory, a disk, a compact disc, or the like.

It should be understood that the terms “system” and “network” herein are interchangeably used in the present disclosure. The term “and/or” herein merely indicates an association relationship describing associated objects, that is, three types of relationships. For example, the phrase “A and/or B” indicates (A), (B), or (A and B). In addition, the character “/” generally indicates an “or” relationship between the associated objects. It is understandable that the term “indicate” in the embodiments of the present disclosure means a direct indication, an indirect indication, or an associated relationship. For example, A indicating B, which mean that A indicates B directly, e.g., B is acquired by A; or that A indicates B indirectly, e.g., A indicates C, wherein B is acquired by C; or that an association relationship is present between A and B. It is understandable that the term “corresponding” may indicate a direct corresponding relationship or indirect corresponding relationship between two objects, or indicate an association relationship between two objects, or indicate relationships such as indicating and being indicated, configuring and being configured, or the like. It is understandable that the “predefined,” “protocol agreement,” “predetermined,” or “a predefined rule” is implemented by pre-storing a corresponding code, a table, or another manner that may indicate related information in the device (for example, the terminal device or the network device), and the specific implementations are not limited in the present disclosure. For example, the term “predefined” refers to defined in a protocol. It is understandable that the term “protocol” indicates a standard protocol in the field of communications. For example, the protocols include the LTE protocol, the NR protocol, and related protocols applied to the future communication system, which are not limited in the present disclosure.

Described above are merely embodiments of the present disclosure and are not intended to limit the present disclosure. Any modification, equivalent replacement, and improvement within the spirit and principle of the present disclosure shall be included within the protection scope of the present disclosure.

1. A method for indicating timing advances (TAs), applicable to a terminal device, the method comprising:
receiving downlink signaling, wherein the downlink signaling at least carries a first association parameter, the first association parameter having an association relationship with a first TA, and the first association parameter corresponding to a first spatial filter; and
updating a TA of the first spatial filter based on the downlink signaling.

2. The method according to claim 1, wherein
the downlink signaling carries the first association parameter and the first spatial filter; or
the downlink signaling carries the first association parameter.

3. The method according to claim 2, wherein in a case that the downlink signaling carries the first association parameter and the first spatial filter, an associated TA of the first association parameter comprises a plurality of TAs, wherein the plurality of TAs comprise the first TA, and the associated TA is preconfigured with the association relationship with the first association parameter.

4. The method according to claim 3, wherein the downlink signaling is a first medium access control (MAC) control element (CE), wherein the first MAC CE comprises an association parameter indicator field and a TA command field, a value carried by the association parameter indicator field being a value of the first association parameter, and a value carried by the TA command field being a value of the first TA.

5. The method according to claim 4, further comprising:
receiving first radio resource control (RRC) signaling, wherein the first RRC signaling is defined to configure an association relationship between the first association parameter and m TAs, wherein the m TAs comprise the first TA, and m is a positive integer greater than or equal to 1.

6. The method according to claim 2, wherein in a case that the downlink signaling carries the first association parameter and the first spatial filter, the first association parameter does not have a TA preconfigured with the association relationship.

7. The method according to claim 6, wherein the downlink signaling is third medium access control (MAC) control element (CE), wherein the third MAC CE is defined to configure the association relationship between the first association parameter and the first TA.

8. The method according to claim 1, wherein a parameter type of the first association parameter comprises:
a unified transmission configuration indication (TCI) state; or
an uplink power control parameter.

9. The method according to claim 8, wherein
the uplink power control parameter is associated with the unified TCI state; or
the uplink power control parameter is not associated with the unified TCI state.

10. The method according to claim 9, wherein in the case that the uplink power control parameter is associated with the unified TCI state, the unified TCI state is associated with at least one group of uplink power control parameters;
wherein one group in the at least one group of uplink power control parameters has the association relationship with a TA.

11. The method according to claim 9, wherein
in a case that the uplink power control parameter is associated with the unified TCI state, the unified TCI state is associated with at least one group of uplink power control parameters; and
the method further comprises:
receiving indication signaling in a case that a plurality of groups in the at least one group of uplink power control parameters have an association relationship with a TA, wherein the indication signaling is defined to activate one of the plurality of groups.

12. A terminal device, comprising:
a processor;
a transceiver coupled to the processor; and
a memory, configured to store one or more executable instructions of the processor;
wherein the processor, when loading and executing the one or more executable instructions, is caused to perform:
receiving downlink signaling, wherein the downlink signaling at least carries a first association parameter, the first association parameter having an association relationship with a first TA, and the first association parameter corresponding to a first spatial filter; and
updating a TA of the first spatial filter based on the downlink signaling.

13. The terminal device according to claim 12, wherein
the terminal device is applicable to intra-cell beam management; or
the terminal device is applicable to inter-cell mobility management.

14. The terminal device according to claim 13, wherein in a case that the terminal device is applicable to the inter-cell mobility management, the downlink signaling further comprises a physical cell identifier (PCI) indicator field, wherein the PCI indicator field indicates a neighbor cell.

15. The terminal device according to claim 13, wherein in a case that the terminal device is applicable to the intra-cell beam management, the processor, when loading and executing the one or more executable instructions, is further caused to perform:
determining the first TA by measuring a downlink reception time difference between a first measurement resource and a second measurement resource; and
transmitting the first TA to a network device;
wherein the first measurement resource corresponds to the first spatial filter, the second measurement resource is one measurement resource of a known TA value, and the second measurement resource corresponds to a second spatial filter.

16. The terminal device according to claim 13, wherein in a case that the terminal device is applicable to the inter-cell mobility management, the processor, when loading and executing the one or more executable instructions, is further caused to perform:
causing a network device to determine the first TA corresponding to a neighbor cell by transmitting a physical random access channel (PRACH).

17. The terminal device according to claim 12, wherein the first TA corresponds to difference-based TA update, or the first TA corresponds to absolute value-based TA update.

18. A network device, comprising:
a processor;
a transceiver coupled to the processor; and
a memory, configured to store one or more executable instructions of the processor;
wherein the processor, when loading and executing the one or more executable instructions, is caused to perform:
transmitting downlink signaling, wherein the downlink signaling at least carries a first association parameter, the first association parameter having an association relationship with a first TA, and the first association parameter corresponding to a first spatial filter;
wherein the downlink signaling is configured for the terminal device to update a TA of the first spatial filter.

19. The network device according to claim 18, wherein a parameter type of the first association parameter comprises:
a unified transmission configuration indication (TCI) state; or
an uplink power control parameter.

20. The network device according to claim 18, wherein
the network device is applicable to intra-cell beam management; or
the network device is applicable to inter-cell mobility management.
